(19) United States
(12) Patent Application Publication
(10) Pub. No.: US 2016/0039024 A1
(43) Pub. Date: Feb. 11, 2016

(54) CUTTING TOOL FOR PROCESSING NUT OF SLIDING SCREW DEVICE AND METHOD FOR PROCESSING NUT OF SLIDING SCREW DEVICE

(71) Applicants: JUKO SEIKI CO., LTD., Gunma (JP); MAEBASHI NETSUSYORI CO., LTD., Gunma (JP)

(72) Inventor: Koujiro Haruta, Gunma (JP)

(73) Assignees: Juko Seiki Co., Ltd., Gunma (JP); Maebashi Netsusyori Co., Ltd., Gunma (JP)

(21) Appl. No.: 14/782,859

(22) PCT Filed: Mar. 21, 2014
(86) PCT No.: PCT/JP2014/057928

§ 371 Date: Oct. 7, 2015

(30) Foreign Application Priority Data
Apr. 8, 2013 (JP) 2013-080062

(51) Int. Cl. B23G 5/06; F16H 25/24

(52) U.S. Cl. CPC B23G 5/06; F16H 25/24; B23G 2210/21; B23G 2210/48

(57) ABSTRACT

Provided are a nut processing cutting tool configured to form an internal thread at the inner peripheral surface of a nut of a sliding screw device with high accuracy, high strength, and low cost, and a nut processing method therefor. A nut processing cutting tool (1) includes a cylindrical cutter (4) and a recessed groove (3) formed in a helical pattern at the outer peripheral surface (2) of the cutter (4). The recessed groove (3) forms, by cutting, a ridge portion (13) of an internal thread (11) corresponding to the shape of the recessed groove (3) at the inner peripheral surface of a nut (10). Thus, the internal thread (11) can be formed at the inner peripheral surface of the nut (10) of the sliding screw device (100) with high accuracy, high strength, and low cost.

### TECHNICAL FIELD

The present invention relates to a cutting tool for processing a nut of a sliding screw device to form an internal thread, and to a method for processing a nut of a sliding screw device.

### BACKGROUND ART

A sliding screw device configured such that a resin nut is screwed onto a screw shaft has been typically known as a device that converts rotational movement into linear movement to transmit the converted movement (for example, Patent Literature 1). In the resin nut used for the sliding screw device of this type, the entirety of the nut or only a thread portion is molded by injection molding using an injection mold.

Further, a ball screw device configured such that a ball is interposed between a screw shaft and a nut has been known as another device that converts rotational movement into linear movement to transmit the converted movement (for example, Patent Literature 2). In a method for processing a nut for a ball screw device as described in Patent Literature 2, pre-processing is performed by lathe turning to form a thread groove, and then, lapping is performed as finishing.

### CITATION LIST

### Patent Literature

Patent Literature 1: Japanese Patent No. 4226249 (page 4, FIG. 1)

Patent Literature 2: Japanese Patent No. 2600425 (pages 3 and 4, FIG. 1)

### SUMMARY OF THE INVENTION

### Problems to Be Solved by the Invention

As compared to the ball screw device, the sliding screw device has advantages that the number of components is lower and that a simpler structure is employed. However, in the sliding screw device employing the resin nut as in the related art described in Patent Literature 1, it is difficult to produce great transmission power at high speed.

That is, the mechanical strength of a resin material is typically inferior to that of a metal material. Since a resin nut has a lower strength of a thread portion as compared to that of a metal nut, the resin nut is not suitable for the purpose of transmitting great load.

In addition, the resin material has a lower coefficient of thermal conductivity than that of the metal material. For this reason, there are problems that the resin nut has poor heat radiation properties and is susceptible to the influence of heat. Specifically, when the sliding screw device is driven at high speed, the resin nut and the screw shaft expand due to heat of the thread portion generated by slide friction. Due to the difference in the linear coefficient of expansion, a clearance decreases and friction resistance increases.

Further, the resin material has a lower thermal resistance than that of the metal material. For this reason, the resin material itself may be degraded due to friction heat of the thread portion. In addition, depending on a resin material to be used, weather resistance, water absorbability, or the like should be taken into consideration. Aging of the material also becomes an issue.

On the other hand, the ball screw device of the related art described in Patent Literature 2 includes the ball, in addition to the screw shaft and the nut. For this reason, the number of components increases and thus a structure becomes more complicated. Thus, there is a problem that it is difficult to reduce a manufacturing cost.

Further, in the case of employing, instead of the resin nut, the metal nut in the sliding screw device, there is a problem that processing of the nut, particularly formation of an internal thread at a nut inner peripheral surface, becomes difficult.

Specifically, in order to provide a sliding screw device with high accuracy and high efficiency, it is necessary to form a thread portion with high accuracy. Accordingly, as in the related art described in Patent Literature 2, grind finishing is required after lathe turning in formation of the nut thread portion.

Typically, a tap has been used as a tool for forming an internal thread for fastening. However, the tap of the related art is for cutting a valley portion of the internal thread, and therefore, it is impossible to cut, with high accuracy, a ridge portion of the internal thread to a tip end (an inner end portion) thereof. For this reason, the tap of the related art cannot be used for the nut used for the sliding screw device, i.e., for the purpose requiring that the ridge portion of the internal thread is, across the entirety including the tip end, formed into a predetermined shape with high accuracy.

Moreover, the tap of the related art is suitable for formation of a typical internal thread having a small pitch and a small lead, which is used for fastening. Thus, in the case of forming a large-lead internal thread, i.e., a large-pitch multi-start internal thread, as in a nut of a sliding screw device, it is difficult to use the tap of the related art in light of cutting resistance and tool strength.

The present invention has been made in view of the above-described circumstances. An object of the present invention is to provide a nut processing cutting tool configured to form, with high accuracy, high strength, and low cost, an internal thread at the inner peripheral surface of a nut of a sliding screw device.

Another object of the present invention is to provide a nut processing method for efficiently producing a nut of a sliding screw device with high strength, high accuracy, and low resistance.

### Solutions to the Problems

A nut processing cutting tool of a sliding screw device according to the present invention includes a cylindrical cutter; and a recessed groove formed in a helical pattern at the outer peripheral surface of the cutter. The recessed groove cuts, by cutting, a ridge portion of the thread corresponding to the shape of the recessed groove at the inner peripheral surface of the nut.

The method for processing a nut of a sliding screw device according to the present invention at least includes the steps of processing a material of the nut to form a prepared hole; forming a thread at an inner peripheral surface of the nut by inserting a nut processing cutting tool into the prepared hole by relative rotation of the nut processing cutting tool; and hardening the inner peripheral surface formed with the thread. The nut processing cutting tool includes, at an outer peripheral surface of a cylindrical cutter, a recessed groove which has an arc-shaped cross section, which extends in a helical pattern, and whose bottom portion has a diameter larger than the diameter of the prepared hole. In the step of forming the thread, the recessed groove forms, by cutting, a ridge portion of the thread to have an arc-shaped cross section and extend in a helical pattern.

### Advantageous Effects of the Invention

The nut processing cutting tool of the sliding screw device of the present invention includes the cylindrical cutter; and the recessed groove formed in the helical pattern at the outer peripheral surface of the cutter. The recessed groove forms, by cutting, the ridge portion of the thread corresponding to the shape of the recessed groove at the inner peripheral surface of a nut. Thus, according to the nut processing cutting tool and the nut processing method of the present invention, the internal thread can be formed at the inner peripheral surface of the nut of the sliding screw device with high accuracy, high strength, and low cost.

With the nut processing cutting tool of the present invention, even if a metal nut is used, an internal thread can be easily formed with high accuracy. Thus, a metal material having a higher strength than that of a resin material can be employed as a nut material of the sliding screw device. As a result, a nut having excellent strength and durability can be provided.

With the nut processing cutting tool of the present invention, a high-accuracy screw thread corresponding to the shape of the recessed groove can be formed only by a single cutting step under predetermined conditions. That is, a ridge portion of an internal thread having the substantially same shape as that of the recessed groove can be formed by one time cutting work with high accuracy across the entirety including a tip end portion (an inner end portion). Thus, the number of steps for thread cut processing can be reduced, the step of thread grind finishing can be skipped, and a nut manufacturing cost can be reduced.

Since a high-accuracy smooth screw thread can be formed at the nut, the position of the sliding screw device can be accurately controlled. Further, the sliding resistance can be reduced and thus a friction loss can be reduced.

Since the recessed groove is shaped to have an arc-shaped cross section, a thread ridge portion having an arc-shaped cross section can be formed at the nut of the sliding screw device. Thus, the relative position between the nut and the screw shaft can be accurately maintained while the contact area between the thread ridge portion of the nut and a thread ridge (valley) portion of the screw shaft can be reduced. This can reduce the sliding resistance of the sliding screw device.

Since the recessed groove is shaped to have an arc-shaped cross section, the screw shaft can be shared with the screw shaft of the ball screw device. Such sharing of the component with the ball screw device can reduce the cost for manufacturing the sliding screw device. In addition, a user of the screw device can optionally select the sliding screw device or the ball screw device according to the load condition of the intended use.

Since the diameter of a prepared hole formed at the nut is smaller than the diameter of a bottom portion of the recessed groove, the ridge portion of the thread formed at the inner peripheral surface of the nut is formed with high accuracy across the entirety including the inner tip end portion. That is, the recessed groove of the nut processing cutting tool of the present invention is configured so that the ridge portion of the internal thread can be formed, at the inner peripheral surface of the nut, corresponding to the shape of the recessed groove. Thus, the diameter of the prepared hole can be suitably adjusted, and therefore, a high-accuracy ridge portion of an internal thread can be reliably formed.

Furthermore, a discharge groove for discharging chips may be formed at the outer peripheral surface of the cutter, and the discharge groove may be formed in a helical pattern inverted from that of the recessed groove. This improves the cutting performance of the nut processing cutting tool. Thus, a high-accuracy internal thread can be more easily formed by cutting work.

### BRIEF DESCRIPTION OF THE DRAWINGS

FIG. 1 is a perspective view illustrating the outline structure of a sliding screw device according to an embodiment of the present invention.

FIG. 2 is a longitudinal sectional view of a nut portion of the sliding screw device according to the embodiment of the present invention.

FIG. 3(A) is an external view illustrating a nut processing cutting tool according to the embodiment of the present invention.

FIG. 3(B) is a cross-sectional view of FIG. 3(A).

FIG. 4 is an external view illustrating a variation of the nut processing cutting tool according to the embodiment of the present invention.

FIG. 5(A) is a view illustrating formation of a prepared hole in a method for processing a nut according to the embodiment of the present invention.

FIG. 5(B) is a view illustrating formation of a thread.

FIG. 5(C) is a view illustrating a state after formation of the thread.

### DESCRIPTION OF EMBODIMENTS

A cutting tool for processing a nut of a sliding screw device and a method for processing a nut of the sliding screw device according to an embodiment of the present invention will be described below in detail with reference to drawings.

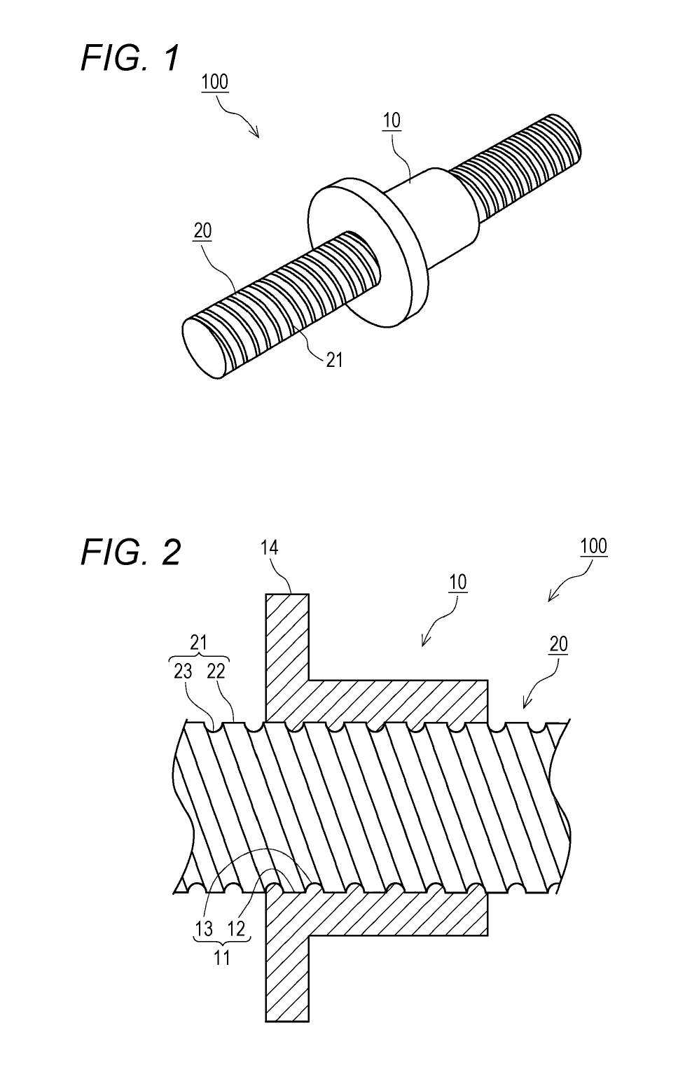

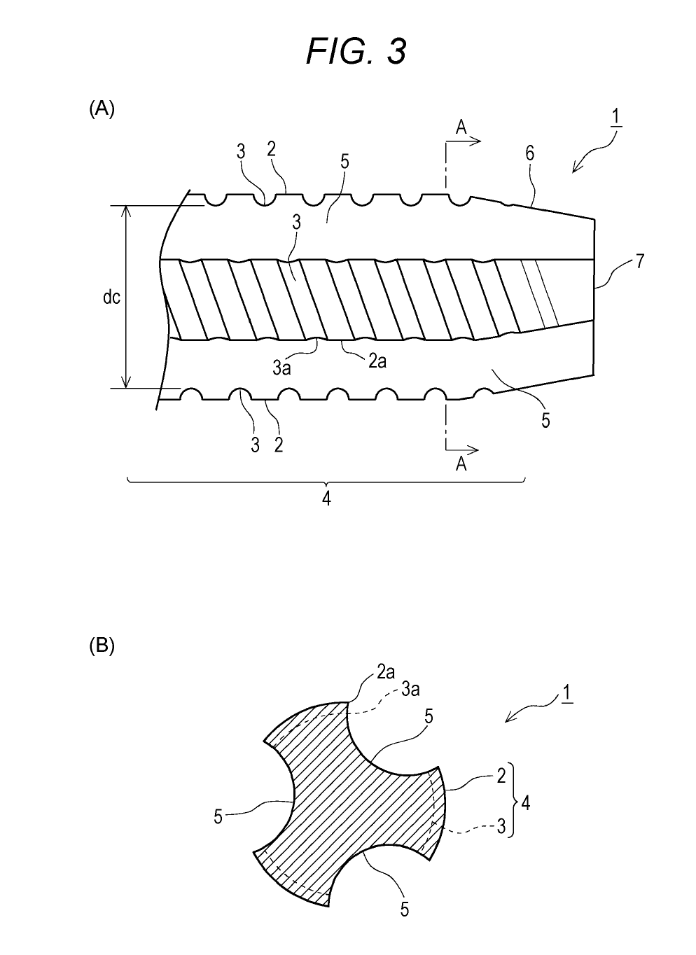

FIG. 1 is a perspective view illustrating the outline structure of a sliding screw device 100 including a nut 10 which is processed using a nut processing cutting tool 1 (see FIGS. 3(A) and 3(B)) of the embodiment of the present invention.

The sliding screw device 100 is a power transmission device configured to convert rotational movement into linear movement, and for example, is used as linear feed means in a typical mechanical device such as a manufacturing device. As illustrated in FIG. 1, the sliding screw device 100 includes a screw shaft 20 having a thread formed at the outer periphery thereof, and the nut 10 screwed onto the screw shaft 20.

The screw shaft 20 is a drive shaft having an external thread 21 formed at the outer periphery thereof. When the sliding screw device 100 is used, the screw shaft 20 is, in the vicinity of both end portions, rotatably supported by an unillustrated bearing unit. One end of the bearing unit is connected to a motor (not illustrated) or the like serving as a drive source via a coupling (not illustrated).

Further, the screw shaft 20 is made of a steel material such as structural carbon steel or chrome molybdenum steel. The surface of the external thread 21 is subjected to hardening treatment by, for example, induction hardening or carburizing and quenching.

The nut 10 is rotatably screwed onto the screw shaft 20 to serve as a follower of the transmission device. When the sliding screw device 100 is used, a follower component (for example, a table of a machine tool) is fixed to the nut 10 via an unillustrated bracket, if necessary.

With the above-described configuration, when the screw shaft 10 is rotatably driven by the unillustrated motor, the nut 10 moves in the axial direction of the screw shaft 10, and therefore the above-described follower component can move linearly.

In the present embodiment, a metal material such as aluminum is used as the material for the nut 10. As compared to synthetic resin materials, such a metal material has good wear resistance and heat radiation properties, as well as a high strength. For this reason, the aluminum employed as the material for the nut 10 allows the sliding screw device 100 to exhibit a high transmission power and a high power transmission efficiency. Thus, the sliding screw device 100 can be used for the purpose requiring a relatively high load and a relatively high speed.

FIG. 2 is a view illustrating the structure of a screwed portion between the nut 10 and the screw shaft 20 in the sliding screw device 100, and illustrates the longitudinal section of the nut 10 and the exterior appearance of the screw shaft 20.

As illustrated in FIG. 2, the external thread 21 is formed at the outer periphery 22 of the screw shaft 20. Specifically, a valley portion 23 having a substantially arc-shaped cross section and extending in a helical pattern is formed at the outer periphery 22 which is the side surface of the substantially cylindrical screw shaft 20. More specifically, the cross-sectional shape of the valley portion 23 is a substantially semi-circular shape. The valley portion 23 is a portion corresponding to the valley of the external thread 21, and is formed to have a predetermined pitch, lead, and number of threads.

After formation of the valley portion 23, the outer periphery 22 serves as a portion protruding in the radial direction of the screw shaft 20, extending in a helical pattern, and corresponding to the ridge of the external thread. As described above, the outer periphery 22 is the outer peripheral surface of the substantially cylindrical screw shaft 20. Thus, as viewed in the cross section in the axial direction, the outer periphery 22 serving as the ridge of the external thread 21 is linearly provided in parallel to the screw shaft.

As described above, at the outer peripheral surface of the screw shaft 20, the valley portion 23 and the outer periphery 22 form the external thread 21. The external thread 21 is screwed with an internal thread 11 of the nut 10.

At the inner peripheral surface of the nut 10, the internal thread 11 is formed by a later-described processing method. Specifically, the internal thread 11 is formed of a ridge portion 13 and a valley portion 12.

The valley portion 12 of the internal thread 11 has a shape corresponding to the outer periphery 22 of the external thread 21. The valley portion 12 is linearly provided in parallel to the center axis of the internal thread 11 as viewed in the cross section in the axial direction. Moreover, the valley portion 12 extends in a helical pattern along the substantially cylindrical inner peripheral surface of the nut 10. The valley portion 12 of the internal thread 11 is in contact with the outer periphery 22 of the external thread 21. Thus, the nut 10 is rotatably supported on the screw shaft 20.

The ridge portion 13 of the internal thread 11 protrudes inwardly from the inner peripheral surface of the nut 10, i.e., the surface at which the valley portion 12 is formed. The ridge portion 13 of the internal thread 11 has a substantially arc-shaped cross section, and is formed in a helical pattern. More specifically, the ridge portion 13 is formed to have a substantially semi-circular cross section. The ridge portion 13 of the internal thread 11 has a shape corresponding to the valley portion 23 of the external thread 20. The ridge portion 13 is in contact with the valley portion 23, thereby converting the rotational movement of the screw shaft 20 into the axial movement of the nut 10 and transmitting such movement.

It is noted that, at the nut 10, a flange 14 for fixing the nut 10 to the unillustrated bracket and other unillustrated screw holes for fixation may be formed, for example.

The screw shaft 20 of the present embodiment may be used as a screw shaft of a ball screw device. That is, the valley portion 23 having the substantially semi-circular cross section, which corresponds to the ridge portion 13 of the nut 10, is formed at the screw shaft 20. Accordingly, the valley portion 23 can be used as a ball rolling groove. Thus, the screw shaft 20 of the sliding screw device 100 can be shared with the ball screw device, resulting in reduction in cost for manufacturing the screw shaft 20. Moreover, the sliding screw device or the ball screw device can be optionally selected and used according to the intended purpose.

FIG. 3(A) is an external view illustrating the outline shape of the vicinity of a cutter 4 of the nut processing cutting tool 1. FIG. 3(B) is a cross-sectional view (cross-sectional view taken along the line A-A of FIG. 3(A)) of the nut processing cutting tool 1.

The nut processing cutting tool 1 is a tool for cutting the inner peripheral surface of the nut 10 (see FIG. 2) to form the internal thread 11 (see FIG. 2). As illustrated in FIGS. 3(A) and 3(B), the nut processing cutting tool 1 has the substantially cylindrical cutter 4. A recessed groove 3 having a substantially arc-shaped cross section and extending in a helical pattern is formed at the outer peripheral surface 2 of the cutter 4.

A portion, bounded by the recessed groove 3, of the outer peripheral surface 2 has an axial cross section of a linear shape in parallel to the axis of the nut processing cutting tool 1, protrudes in the radial direction, and extends in a helical pattern. The outer peripheral surface 2 serves as a blade for cutting the valley portion 12 (see FIG. 2) of the nut 10. More specifically, an edge portion where a later-described discharge groove 5 and the outer peripheral surface 2 intersect with each other serves as a blade portion 2a for cutting the valley portion 12.

The recessed groove 3 is a recess having a substantially semi-circular cross section. The recessed groove 3 is formed in a helical pattern along the outer peripheral surface 2 of the cutter 4. Moreover, the recessed groove 3 serves as a blade for cutting the ridge portion 13 (see FIG. 2) of the nut 10. Specifically, an edge portion where the discharge groove 5 and the recessed groove 3 intersect with each other serves as a blade portion 3a for cutting the ridge portion 13. More specifically, the entirety of the blade portion 3a of the recessed groove 3 including a bottom portion of the recessed groove 3 having the substantially semi-circular cross section serves as a blade for cutting the ridge portion 13. Thus, the ridge portion 13 having a substantially semi-circular cross section, which corresponds to the shape of the recessed groove 3 (i.e., the substantially same shape as that of the recessed groove 3), is formed at the nut 10 by cutting work.

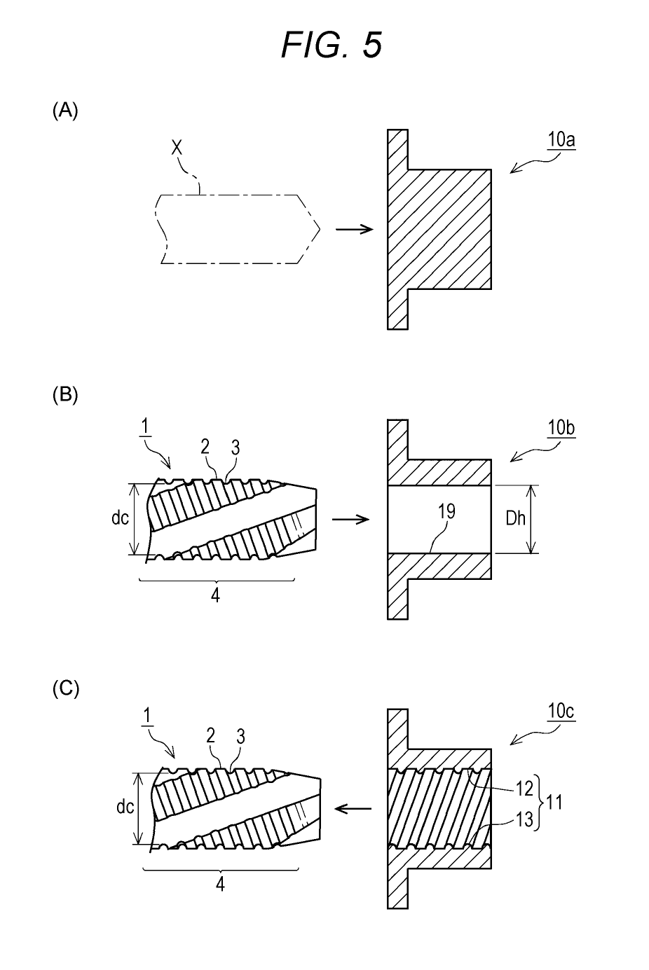

The diameter dc of the bottom portion of the recessed groove 3 is larger than the diameter Dh of a prepared hole 19 (see FIGS. 5(A) to 5(C)) of the nut 10. In other words, in formation of the internal thread 11, the prepared hole 19 is formed to have the diameter Dh smaller than the diameter dc of the bottom portion of the recessed groove 3. Thus, the ridge portion 13 of the nut 10 is cut to a tip end portion (an inner end portion). In this manner, the ridge portion 13 can be formed with high accuracy to have a substantially semi-circular cross section corresponding to the shape of the recessed groove 3.

A tapered portion 6 in the vicinity of a tip end 7 of the cutter 4 is formed in a tapered shape such that the outer diameter of the cutter 4 gradually decreases toward the tip end 7. This facilitates the operation of inserting the nut processing cutting tool 1 into the prepared hole 19. Moreover, the cutting resistance at the beginning of cut processing is reduced, and a favorable processed surface can be formed.

As illustrated in FIG. 3(B), the discharge groove 5 for discharging chips is formed at the cutter 4 of the nut processing cutting tool 1. The discharge groove 5 is a groove formed to have a substantially arc-shaped cross section at the outer peripheral surface 2. The discharge groove 5 extends in the axial direction of the nut processing cutting tool 1, and opens at least in the direction toward the tip end 7. With the discharge groove 5, chips formed due to cutting can be discharged to the outside, and can be prevented from being clogged and jammed. It is noted that the cross-sectional shape of the discharge groove 5 is not limited to an arc shape, and various shapes can be employed. Moreover, the discharge groove 5 may be formed in a helical pattern. The details will be described later with reference to specific examples.

The material for the nut processing cutting tool 1 is not particularly limited, but cemented carbide containing tungsten carbide as a main component or high-speed tool steel can be used, for example.

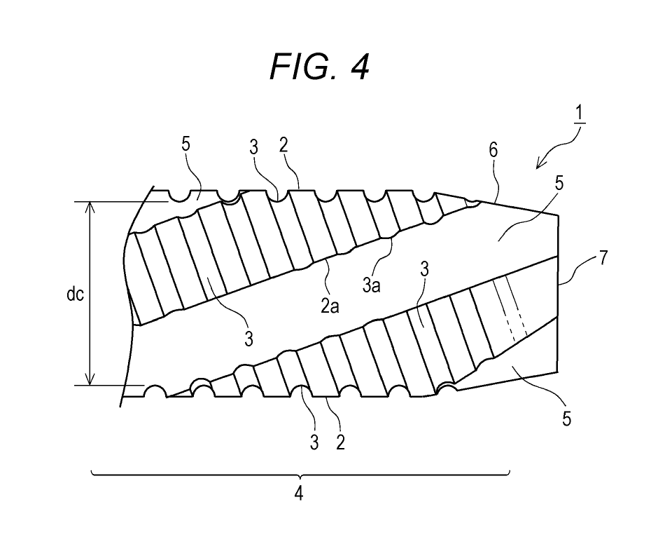

Next, a variation of the nut processing cutting tool 1 will be described with reference to FIG. 4. In this variation, the discharge groove 5 is in a helical pattern. This variation is different from the above-described embodiment in this point.

FIG. 4 is an external view illustrating the outline shape of the vicinity of the cutter 4 of the nut processing cutting tool 1. In FIG. 4, the same reference numerals are used to represent elements providing the identical or similar features and advantageous effects to those of the above-described embodiment.

As illustrated in FIG. 4, in the present variation, the discharge groove 5 is not in a linear pattern but in a helical pattern. Specifically, the discharge groove 5 is in a helical pattern inverted from that of the recessed groove 3. This increases the angle between the recessed groove 3 and the discharge groove 5, and thus the shapes of the blade portion 3a of the recessed groove 3 and the blade portion 2a of the outer peripheral surface 2 approach a shape suitable for cutting. As a result, the cutting performance of the nut processing cutting tool 1 is improved, and thus an internal thread can be formed with high accuracy.

In order to provide favorable cutting performance, a large angle between the discharge groove 5 and the recessed groove 3 is preferable. Most preferably, the discharge groove 5 and the recessed groove 3 are formed to be substantially perpendicular to each other.

Typically, a thread for a transmission device such as the sliding screw device 100 (see FIG. 1) has a large lead (pitch x the number of threads) as compared to that of a typical thread for fastening. For this reason, such a thread is difficult to be formed. According to the nut processing cutting tool 1 of the present invention, the discharge groove 5 is in the helical pattern inverted from that of the recessed groove 3, and the angle between the discharge groove 5 and the recessed groove 3 is large, as described above. Thus, excellent cutting performance is exhibited, and formation of the internal thread 11 (see FIG. 2) is facilitated.

The lead of the internal thread 11, i.e., the lead of the recessed groove 3, is set at various suitable values according to the intended use of the sliding screw device 100. Thus, the lead (or the lead angle) of the discharge groove 5 can be suitably set according to the lead (or the lead angle) of the recessed groove 3. Specifically, when the lead (or the lead angle) of the recessed groove 3 is large, the lead (or the lead angle) of the discharge groove 5 is decreased. This can provide a nut processing cutting tool 1 capable of cutting internal threads 11 with various dimensions under suitable conditions.

Next, the method for processing the nut according to the present embodiment, particularly the method for forming the internal thread 11, will be described with reference to FIGS. 5(A) to 5(C).

FIGS. 5(A) to 5(C) are views illustrating the method for processing the nut. FIG. 5(A) illustrates formation of the prepared hole 19. FIG. 5(B) illustrates formation of the internal thread 11. FIG. 5(C) illustrates the state after the internal thread 11 is formed.

The method for processing the nut according to the present embodiment at least includes a step of processing a material 10a of the nut 10 to form the prepared hole 19, a step of inserting the nut processing cutting tool 1 into the prepared hole 19 by the relative rotation of the nut processing cutting tool 1 and processing the inner peripheral surface of a material 10b of the nut 10 to form the internal thread 11, and a step of hardening the inner peripheral surface of a material 10c formed with the internal thread 11.

First, as illustrated in FIG. 5(A), the material 10a of the nut 10 is prepared, and the prepared hole 19 is formed by a drill X. Thus, as illustrated in FIG. 5(B), the prepared hole 19 penetrating the material 10a is formed.

Next, as illustrated in FIG. 5(B), the cutter 4 of the nut processing cutting tool 1 is inserted into the prepared hole 19 of the material 10b formed with the prepared hole 19. Then, the nut processing cutting tool 1 rotates relative to the material 10b at a predetermined rotation speed to form an internal thread 11 by cutting work as illustrated in FIG. 5(C).

That is, at the inner peripheral surface of the material 10b, the valley portion 12 of the internal thread 11 is formed by cutting work by the outer peripheral surface 2 of the nut processing cutting tool 1, and the ridge portion 13 is formed by cutting work by the recessed groove 3.

As described above, the diameter Dh of the prepared hole 19 is formed smaller than the diameter dc of the bottom portion of the recessed groove 3 of the nut processing cutting tool 1. Thus, the ridge portion 13 protruding in a substantially semi-circular shape corresponding to the shape of the recessed groove 3 can be formed at the inner peripheral surface of the nut 10 with high accuracy.

In addition, the recessed groove 3 is formed in a helical pattern. Accordingly, the rotation of the nut processing cutting tool 1 relative to the material 10b allows the nut processing cutting tool 1 to move in the axial direction of the prepared hole 19. Thus, the pressing force for moving the nut processing cutting tool 1 in the axial direction is relatively small, and therefore the size of a nut manufacturing device (a thread cutting device) can be reduced.

With the nut processing cutting tool 1, suitable control of the rotation speed of the nut processing cutting tool 1 allows smooth and high-accuracy formation of the processed surface of the internal thread 11. Thus, the internal thread 11 can be formed with high accuracy only by a single step of rotating the nut processing cutting tool 1 to insert the nut processing cutting tool 1 into the prepared hole 19.

With this configuration, it is not necessary to perform grind finishing after the internal thread 11 is formed by cutting work. Thus, the cost for manufacturing the nut 10 can be reduced due to reduction in the number of steps in nut processing.

Note that the nut processing cutting tool 1 can be inversely rotated after the nut processing cutting tool 1 is rotated and inserted into the prepared hole 19 to form the internal thread 11 by cutting work, so that the nut processing cutting tool 1 can be easily pulled out of the internal thread 11.

Next, as illustrated in FIG. 5(C), at least the internal thread 11 of the material 10c, after the internal thread 11 is formed, is subjected to surface hardening. Specifically, an anodic oxide coating is formed on the surface of the material 10c made of aluminum. This can improve the wear resistance of the internal thread 11. Note that surface hardening may be performed for the entirety of the nut 10.

As described above, according to the nut processing cutting tool 1 of the present invention, the internal thread 11 can be efficiently formed with high accuracy and high strength at the inner peripheral surface of the nut 10.

The present invention is not limited to the above-described embodiments, and various changes can be made without departing from the gist of the present invention.

### DESCRIPTION OF REFERENCE SIGNS

1 Nut processing cutting tool
2 Outer peripheral surface
3 Recessed groove
4 Cutter
5 Discharge groove
10 Nut
11 Internal thread
12 Valley portion
13 Ridge portion
19 Prepared hole
20 Screw shaft
21 External thread
22 Outer periphery (ridge portion)
23 Valley portion
100 Sliding screw device
dc Diameter of bottom portion of recessed groove
Dh Diameter of prepared hole

1-3. (canceled)

4. A method for processing a nut of a sliding screw device, at least comprising the steps of:
processing a material of the nut to form a prepared hole;
forming a thread at an inner peripheral surface of the nut by inserting a nut processing cutting tool into the prepared hole by relative rotation of the nut processing cutting tool; and
hardening the inner peripheral surface formed with the thread, wherein
the material of the nut is aluminum,
the nut processing cutting tool includes, at an outer peripheral surface of a cylindrical cutter, a recessed groove which has an arc-shaped cross section, which extends in a helical pattern, and whose bottom portion has a diameter larger than a diameter of the prepared hole,
in the step of forming the thread, a ridge portion of the thread is formed by cutting by the recessed groove, the ridge portion having an arc-shaped cross section and extending in a helical pattern, and
in the step of hardening, an anodic oxide coating is formed on the inner peripheral surface.

5. The method for processing a nut of a sliding screw device according to claim 4, wherein
a portion, bounded by the recessed groove, of the outer peripheral surface of the nut processing cutting tool has an axial cross section of a linear shape in parallel to the axis of the nut processing cutting tool, and
in the step of forming the thread, a valley portion of the thread is formed by cutting by the portion, bounded by the recessed groove, of the outer peripheral surface, the valley portion having an axial cross section of a linear shape in parallel to the axis.
